(19) United States
(12) Patent Application Publication
(10) Pub. No.: US 2023/0028757 A1
(43) Pub. Date: Jan. 26, 2023

(54) IMAGE DISPLAY ELEMENT, IMAGE DISPLAY DEVICE, AND IMAGE DISPLAY METHOD

(71) Applicant: Hitachi-LG Data Storage, Inc., Tokyo (JP)

(72) Inventors: Hiroyuki MINEMURA, Tokyo (JP); Yumiko ANZAI, Tokyo (JP)

(21) Appl. No.: 17/785,102

(22) PCT Filed: Oct. 8, 2020
(86) PCT No.: PCT/JP2020/038160

§ 371 Date: Jun. 14, 2022

(30) Foreign Application Priority Data
Jan. 10, 2020 (JP) 2020-002824

(51) Int. Cl. G02B 27/01; G02B 27/00; G02B 27/42; G06T 19/00; F21V 8/00; G02B 5/18

(52) U.S. Cl. CPC G02B 27/0172; G02B 27/0081; G02B 27/4272; G06T 19/006; G02B 6/0016; G02B 5/1861; G02B 5/1842; G02B 2027/0118

(57) ABSTRACT

To improve brightness of image information visually recognized by a user while using plastic for a light guide plate. An image display element includes: a substrate made of resin; an incident diffraction grating that diffracts incident light; and an exit diffraction grating that emits the light, the incident diffraction grating being formed on a first surface of the substrate, the exit diffraction grating being formed on a second surface on a side opposite to the first surface of the substrate, and the exit diffraction grating being formed on one surface.

### TECHNICAL FIELD

The present invention relates to a technology in which a light guide plate and a diffraction element are combined, and particularly relates to an image display technology that is compact, lightweight, and capable of performing an augmented reality display.

### BACKGROUND ART

Augmented reality image display devices allow a user to view not only a projected image but also surroundings at the same time. The projected image can be superimposed on a real world that is perceived by the user. Applications of such displays include video games and wearable devices such as glasses. The user can visually recognize the image that is supplied from a projector in the state of being superimposed on the real world by wearing an image display device in the form of eyeglasses or goggles in which a translucent light guide plate and the projector are integrated.

An example of such image display devices is described in “PTL 1” to “PTL 3”. In these patent literatures, a light guide plate includes a plurality of diffraction gratings having a corrugated shape formed on a glass substrate. Light beam emitted from a projector is coupled to the light guide plate by a diffraction grating for incidence, and propagates inside the light guide plate while being totally internally reflected. The light beam propagates in total internal reflection in the light guide plate while being converted into a plurality of light beams replicated by another diffraction grating, and finally exits from the plate light guide. Some of the emitted light beams form an image on a retina through a pupil of a user, and the image is recognized as an augmented reality image overlaid on an image of a real world.

In the light guide plate using such corrugated diffraction gratings, a wavenumber vector K of the light beam emitted from the projector becomes K0 according to Snell's law as the light is refracted in the light guide plate. The diffraction grating for incidence further causes conversion into a wavenumber vector K1 that allows the total internal reflection and propagation inside the light guide plate. The wavenumber vector changes, such as K2, K3, and so on, each time the light beam is diffracted repeatedly due to a diffraction effect of one or a plurality of other diffraction gratings provided in the light guide plate.

Assuming that a wavenumber vector of the light beam finally emitted from the light guide plate is K′, |K′|=|K|, where K′=K in a case where the projector is present on the opposite side of an eye across the light guide plate. On the other hand, in a case where the projector is present on the opposite side of the eye across the light guide plate, the light guide plate has the same effect as a reflective mirror in terms of the wavenumber vector. Assuming that a normal vector of the light guide plate corresponds to a z direction, comparison of wavenumber vector components x, y, and z can be expressed as Kx′=Kx, Ky′=Ky, and Kz′=−Kz.

The light guide plate functions to guide light waves while replicating a light beam emitted from the projector into a plurality of light beams such that the plurality of emitted light beams are perceived by the user as image information equivalent to an original image. At this time, a group of the replicated light beams spatially spreads while having a wavenumber vector equivalent to a light beam having the image information and emitted from the projector. A part of the group of the replicated light beams enters the pupil and forms an image on the retina together with external environment information to be visually recognized, and it is possible to provide the user with augmented reality information added to the external environment information.

Light beams having the image information vary in wavenumber vector magnitude depending on wavelengths thereof. Since the corrugated diffraction grating has a constant wavenumber vector, the diffracted wavenumber vector K1 varies depending on a wavelength of an incident light beam, and light propagates in the light guide plate at different angles. A refractive index of the glass substrate constituting the light guide plate is approximately constant relative to the wavelength, and a range of a condition for guiding light while causing total internal reflection varies depending on a wavelength of an incident light beam. Therefore, it is necessary to stack a plurality of light guide plates that differ per wavelength on each other in order to allow the user to perceive an image with a wide viewing angle. Generally, it is considered that, as for the number of light guide plates, the number of light guide plates respectively corresponding to red light (R), green light (G), and blue light (B), or a range of two to four plates, one more or less than the mentioned number, is considered adequate.

An image display device described in “PTL 1” is an image display device configured to expand input light in two dimensions, and includes three linear diffraction gratings. One diffraction grating is configured for incidence, and the other two diffraction gratings for exit are typically arranged to be overlaid on one another on a front surface and a back surface of the light guide plate, and function as diffraction gratings for replication and exit, respectively. In addition, “PTL 1” describes an example in which the diffraction grating for exit is formed on one surface by periodic structures of pillar-shaped photonic crystals.

An image display device described in “PTL 2” discloses a technology in which optical structures have a shape including a plurality of straight sides in order to solve a problem that an image projected by the photonic crystal in “PTL 1” has high brightness in the central portion of the field of view.

In image display devices described in “PTL 3” and “PTL 4”, three diffraction gratings also serving as an incident diffraction grating, a deflecting diffraction grating, and an exit diffraction grating are arranged without regions being overlaid on each other in a light guide plate. “PTL 3” discloses an overhanging triangular diffraction grating in order to increase diffraction efficiency of an incident diffraction grating.

“PTL 5” and “PTL 6” disclose a technology in which two reflective volume holograms respectively for incidence and exit are used as diffraction gratings formed on a light guide plate. In these, the reflective volume hologram is obtained by forming diffraction gratings corresponding to a plurality of wavelengths in a space in a multiplexed manner, and diffracts light beams of a plurality of wavelengths at the same angle, which is different from the corrugated diffraction grating in “PTL 1” to “PTL 3”. Therefore, a user can recognize an RGB image with one light guide plate. Meanwhile, a wide viewing angle can be achieved since the light beam is replicated in the two-dimensional direction in the light guide plate in the corrugated diffraction grating. However, the reflective volume hologram provides the function of only one-dimensional replication, and thus, has a feature that a viewing angle is relatively narrow.

### CITATION LIST

### Patent Literature

PTL 1: JP 2017-528739 A

PTL 2: WO 2018/178626 A1

PTL 3: WO 2016/130342 A1

PTL 4: WO 99/52002 A1

PTL 5: JP 2007-94175 A

PTL 6: JP 2013-200467 A

### SUMMARY OF INVENTION

### Technical Problem

Hereinafter, a light guide plate having a corrugated diffraction grating will be described as the light guide plate. In addition, in order to facilitate understanding, image inversion by a lens effect of an eye and an effect in which an image projected on a retina is further inverted through processing in a brain before being perceived are left out of description, and a relation between a pixel position and brightness will be discussed regarding a projected image that is projected on a front screen from an image light source arranged on the same side as the eye with respect to the light guide plate. The actually visible image is vertically inverted image thereof.

Regarding a substrate material, “PTL 1” discloses a technology in which the light guide plate is made of a glass material as described with reference to FIG. 15A. Regarding a diffraction grating, a technology in which a waveguide (=glass plate) surface is processed by etching is disclosed as described in paragraph 0017. In addition, as described in paragraph 0039, “PTL 1” discloses a technology of forming a pillar structure exhibiting an increased refractive index relative to the waveguide as the grating using photonic crystals. When the photonic crystal having the pillar shape in “PTL 1” is formed on the surface of the light guide plate by an injection molding method or the like as will be described later, the refractive index of the pillar is equal to that of the waveguide (or substrate). In this case, if an aspect ratio, which is a ratio of a diameter to a height of the pillar, is not about 2 or more, a projected image has insufficient brightness.

The photonic crystal obtained by improving the problem that the brightness is high at the central portion of the projected image described in “PTL 2” is configured such that the optical structures have the shape including the plurality straight sides in order to solve the problem that the image projected by the photonic crystal, which is linear rather than the pillar shape, has high brightness in the central portion of the field of view. In “PTL 2”, a central stripe-like portion having higher brightness is improved as described in line 34 of page 1 and line 8 of page 2. Note that the content of WO 2016/020643 cited in “PTL 2” is the same as that of “PTL 1”. In “PTL 2”, the central stripe portion having higher brightness, which is the problem, is not explicitly disclosed in the drawings and the like.

The incident diffraction grating disclosed in FIG. 5C of “PTL 3” has an overhung triangular cross section as a cross-sectional shape, and it is possible to efficiently couple an image light beam incident from an upper direction (air side) in the drawing to the inside of the hatched light guide plate.

Generally, in an image display element, a light beam having image information is coupled by an incident diffraction grating provided in a light guide plate so as to have a wavenumber that enables the light to be guided in total internal reflection inside the light guide plate, and propagates in the light guide plate. A part of the light beam intersecting an exit diffraction grating is diffracted and emitted from the light guide plate with a wavenumber equivalent to the original image light beam. The image information that is provided to a user has traveling angle information, that is, a wavenumber, depending on a pixel position in the original image information. The image information for one pixel needs to exit from a specific position in the light guide plate, determined by a traveling angle, a distance between the light guide plate and the user's pupil, and a size of the user's pupil, in order to exit from the light guide plate and arrive at the user's pupil.

As described above, the light beam is replicated and emitted with spatial spread in the light guide plate, and thus, the light beam visually recognized by the user decreases as the spatial spread increases, and the visually recognized brightness thereof decreases. Meanwhile, an exit position visually recognized by the user changes depending on the pixel position in the original image information, and thus, the brightness inevitably changes depending on a pixel position in the image display device using the light guide plate.

In the prior arts, it is suitable to use a method of directly etching a glass substrate to prepare a light guide plate, a nanoimprint method suitable for formation of a pattern having a high aspect ratio, or the like. When the photonic crystals of “PTL 1” and “PTL 2” based on the “PTL 1” are used and refractive indices of the substrate and the photonic crystal are the same, it is necessary to set an aspect ratio, which is a ratio between a representative length such as a diameter of a bottom surface to the height thereof, to about 2 or more.

Here, in a case where glass is used for the light guide plate as disclosed in “PTL 1” or the like, there are problems in processing cost and weight at the time of being worn by the user. Therefore, the problems can be solved by using plastic for the light guide plate. Note that the terms “resin” and “plastic” are used synonymously in the present specification and the like. The plastic means a material made of a polymer compound, and is a concept that does not include glass but includes a resin, polycarbonate, an acrylic resin, and a photocurable resin.

When plastic is used for the light guide plate, the diffraction grating can be formed by an injection molding technology or the like that has been proven as a method for manufacturing an optical disk medium. Since an aspect ratio of a surface-relief pattern formed by the injection molding technology or the like does not exceed 1, it is difficult to apply the injection molding technology or the like because the accuracy of pattern transfer decreases when an attempt is made to obtain an aspect ratio of 2 or more. This is a problem caused by the essential principle of the manufacturing method in which a molten polycarbonate resin, acrylic resin, polyolefin resin, or the like has high viscosity, and the resin does not accurately enter irregularities having a high aspect ratio formed with a nanometer period. In addition, the incident diffraction grating of “PTL 3” uses the overhung triangular diffraction grating, and thus, it is difficult to apply the injection molding technology or the like because a matrix (stamper) and the light guide plate are not peelable.

In addition, the plastic light guide plate has a smaller mechanical strength (Young's modulus) than the conventional glass light guide plate, and thus, a deformation thereof caused by the environmental temperature or atmospheric pressure increases. Although details will be described later, it is effective to adopt a transmissive optical configuration in which an image source and the user are located on opposite sides with the light guide plate interposed therebetween in order to reduce the influence of the deformation on the image information. Therefore, it is desirable to adopt a configuration capable of avoiding a decrease in brightness of the image information visually recognized by the user even in the transmissive optical configuration.

In this manner, it is necessary to adopt a configuration in consideration of the manufacturing method and the brightness of the image information in order to apply the plastic light guide plate to the image display element. Therefore, an object of the present invention is to improve brightness of image information that is visually recognized by a user while using plastic for a light guide plate.

### Solution to Problem

A preferred aspect of the present invention is an image display element including: a substrate made of resin; an incident diffraction grating that diffracts incident light; and an exit diffraction grating that emits the light, the incident diffraction grating being formed on a first surface of the substrate, the exit diffraction grating being formed on a second surface on a side opposite to the first surface of the substrate, and the exit diffraction grating being formed on one surface.

Another preferred aspect of the present invention is an image display device on which the above image display element is mounted, the image display device being configured such that image light is incident from the second surface side of the substrate, and the image light can be visually recognized from the first surface side of the substrate.

Another preferred aspect of the present invention is an image display method that is performed using an image display element including a substrate made of resin, an incident diffraction grating formed on a first surface of the substrate, and an exit diffraction grating formed on a second surface on a side opposite to the first surface of the substrate, the exit diffraction grating being formed on one surface. In this method, image light is incident on the incident diffraction grating, the image light reflected and diffracted by the incident diffraction grating propagates inside the substrate, and an image is display by allowing a user to visually recognize the image light reflected and diffracted by the exit diffraction grating and emitted from the first surface.

### Advantageous Effects of Invention

It is possible to improve the brightness of the image information that is visually recognized by the user while using the plastic for the light guide plate.

### BRIEF DESCRIPTION OF DRAWINGS

FIG. 1 is a schematic cross-sectional view illustrating diffraction by an exit diffraction grating.

FIG. 2 is an image view illustrating an example of a phase function of the exit diffraction grating.

FIG. 3 is a perspective view of a mesh-type diffraction grating of an embodiment.

FIG. 4 is a conceptual diagram illustrating a definition of an exit circle as a basis of a simulation.

FIG. 5 is an image view illustrating a simulation result of an intensity distribution of a light beam propagating inside a light guide plate.

FIG. 6 is a schematic cross-sectional view illustrating the light guide plate of the embodiment.

FIG. 7 is a schematic plan view illustrating a relation between a diffraction grating of the light guide plate and a wavenumber vector.

FIG. 8 is an image view illustrating a simulation result of a projected image.

FIG. 9 is an image view of a simulation result illustrating a diffracted light beam of an incident diffraction grating.

FIG. 10 is a schematic cross-sectional view illustrating a configuration example of an image display device.

FIG. 11A is a graph illustrating a relation between a pattern height of the diffraction grating and first-order diffraction efficiency of reflection and transmission.

FIG. 11B is a graph illustrating a relation between the pattern height of the diffraction grating and zero-order reflective diffraction efficiency.

FIG. 11C is a graph illustrating a relation between the pattern height of the diffraction grating and a light intensity of 550 nm visually recognized by the user.

FIG. 11D is a graph illustrating a relation between the pattern height of the diffraction grating and a light intensity of 635 nm visually recognized by the user.

FIG. 11E is a graph illustrating a relation between the pattern height of the diffraction grating and a light intensity of 460 nm visually recognized by the user.

FIG. 12A is a schematic cross-sectional view of an example in which a projector and a pupil of the user are arranged on the same side of the light guide plate.

FIG. 12B is a schematic cross-sectional view of an example in which the projector and the pupil of the user are arranged on opposite sides of the light guide plate.

FIG. 13 is a schematic cross-sectional view illustrating a method for forming a light guide plate of an embodiment.

FIG. 14 is a schematic cross-sectional view illustrating a configuration of an image display device of an embodiment.

### DESCRIPTION OF EMBODIMENTS

Hereinafter, embodiments of the present invention will be described with reference to the drawings. However, the present invention is not construed as being limited to the description of the embodiments to be described below. Those skilled in the art can easily understand that specific configurations can be changed without departing from the spirit or gist of the present invention.

In a configuration of the invention to be described below, the same reference signs will be commonly used for the same parts or parts having similar functions in different drawings, and the redundant description thereof will be omitted in some cases.

When there are a plurality of elements having the same or similar functions, the same reference sign will be sometimes described with different subscripts. When it is unnecessary to distinguish between these plural elements, however, the subscripts will be sometimes omitted in the description.

The notations such as “first”, “second”, and “third” in the present specification and the like are given to identify components, and do not necessarily limit the number, the order, or the content thereof. Further, a number for identifying a component is used for each context, and a number used in one context does not necessarily indicate the same configuration in another context. Further, a component identified by a certain number is not prevented from also serving a function as a component identified by another number.

Positions, sizes, shapes, ranges, and the like of the respective components illustrated in the drawings and the like do not always indicate actual positions, sizes, shapes, ranges and the like in order to facilitate understanding of the invention. Therefore, the present invention is not necessarily limited to the positions, sizes, shapes, ranges, and the like disclosed in the drawings and the like.

The publications, patents, and patent applications cited in the present specification constitute a part of the description of the present specification as they are.

Components expressed by the singular in the present specification are intended to include the plural unless clearly indicated in the context.

In the embodiments to be described hereinafter, an exit diffraction grating is formed on a surface opposite to an incident diffraction grating when a light guide plate made of plastic is applied. With this configuration, highly efficient reflective diffraction can be used for diffraction toward user's eyes, and thus, brightness of image information is improved.

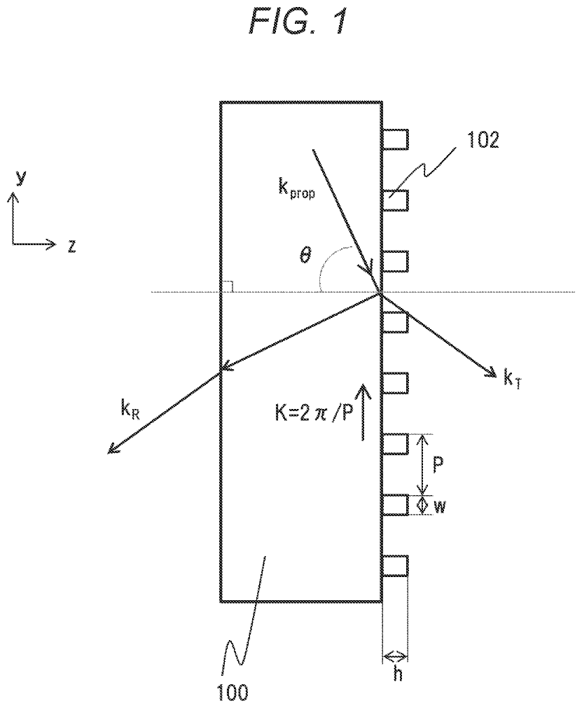

FIG. 1 is a schematic view illustrating a situation in which a light beam propagating inside a light guide plate is emitted to the outside by an effect of the exit diffraction grating. In the drawing, the light guide plate is represented by 100, the exit diffraction grating is represented by 102, a wavenumber vector of a light beam propagating inside is represented by kₚᵣₒₚ, a wavenumber vector of a light beam emitted by reflective diffraction is represented by k_{R}, a wavenumber vector of a light beam emitted by transmissive diffraction is represented by k_{T}, and a wavenumber vector of the exit diffraction grating is represented by K. Note that a rectangular type is exemplified as the exit diffraction grating 102 in FIG. 1, but the invention is not necessarily limited thereto. In the rectangular-type diffraction grating, there is an effect that diffraction efficiency becomes symmetric.

The wavenumber vectors k_{R} and k_{T} are obtained by applying K to the propagating light beam kₚᵣₒₚ based on the principle of diffraction. Therefore, k_{R} and k_{T} are obtained by inverting only the sign of a vector component in a z direction in the drawing. Therefore, the user can visually recognize the image information by viewing any of the light beams of the reflective diffraction and the transmissive diffraction. However, the both form images inverted with respect to x and y directions, and thus, it is necessary to perform image inversion processing by an image source (not illustrated) as necessary.

When a structure period of the exit diffraction grating 102 is P, the magnitude of the wavenumber vector K is 2π/P. Assuming that a width and a height of a convex portion of the exit diffraction grating 102 are w and h, respectively, an aspect ratio is represented by h/w. In the case of the light guide plate 100 prepared by an injection molding method or the like, it is difficult to obtain favorable molding when the aspect ratio h/w exceeds approximately 1. In such a case, reflective diffraction efficiency is greater than transmissive diffraction efficiency. An incident angle θ of the light beam propagating inside the light guide plate 100 to the exit diffraction grating 102 is about 40 to 80 degrees.

When an aspect ratio of a corrugated pattern that is transferred to the surface of the light guide plate 100 is low, it is easy to form the corrugated pattern with a proven plastic molding technology such as the injection molding method. Therefore, in a preferred mode of the present embodiment, a diffraction grating having a two-dimensional mesh pattern is proposed as the exit diffraction grating 102. As a result, the aspect ratio of the corrugated pattern that is transferred to the surface of the light guide plate becomes 1 or less, and the light guide plate 100 suitable to use the plastic molding technology such as the injection molding method can be provided.

A photonic crystal or a diffraction grating described in PTL 1 spatially applies phase modulation to incident light through surface irregularities. The magnitude of the phase modulation increases in proportion to a difference in refractive index between a surface structure and air and a height of the surface irregularities.

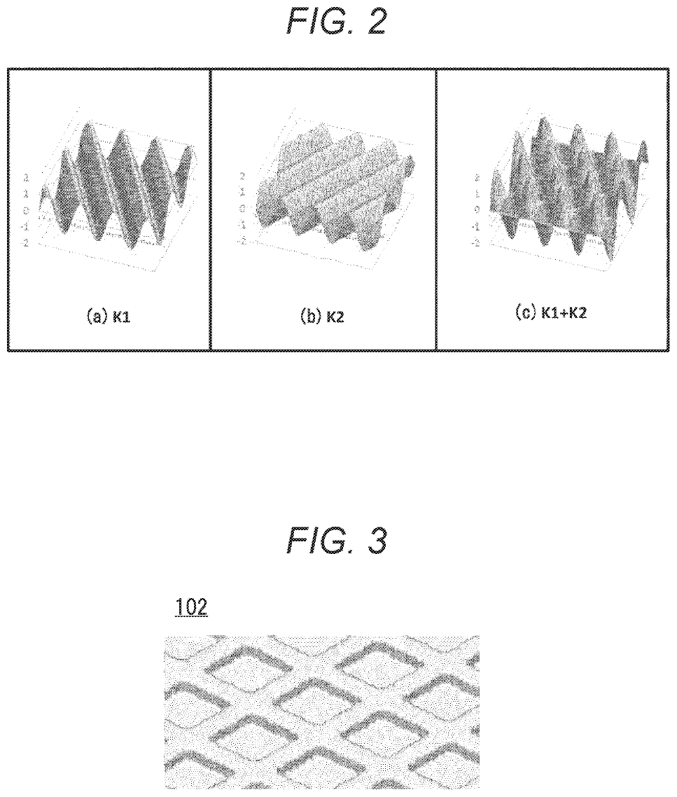

FIG. 2 schematically illustrates a wavenumber of the exit diffraction grating. Phase functions of the diffraction gratings having wavenumbers K1 and K2 having an azimuth angle of ±60 degrees with respect to the Y axis are illustrated in FIGS. 2(a) and 2(b), respectively, and each has a sinusoidal phase distribution. The amount of phase modulation is normalized to 1. FIG. 2(c) is obtained by combining the both. It can be said that the photonic crystal of PTL 1 is obtained by forming the diffraction grating of FIG. 2(c), approximated to pillars or the like, on the surface of the light guide plate using a material having a high refractive index. As can be seen from FIG. 2(c), a maximum value of the phase modulation amount of K1+K2 is 2, and it is found that a height (aspect ratio) which is twice as high as that of the single sinusoidal diffraction grating in FIGS. 2(a) and 2(b) is required when the diffraction grating of FIG. 2(c) is approximated to an isolated pillar or the like.

FIG. 3 is an example of the mesh-like exit diffraction grating 102 of the embodiment. As compared with FIG. 2(c), the diffraction grating of FIG. 3 does not have a sinusoidal structure, and thus, has a higher-order wavenumber component when being subjected to Fourier transform, but can make a wavenumber component of a second or higher order non-diffractive (set a wavenumber to be an imaginary number) with respect to incident light by appropriately selecting a period in the case of being used as the light guide plate. In addition, the mesh-like diffraction grating is obtained by superimposing rectangular diffraction gratings of ±60 degrees on each other, and does not have a wavenumber component other than directions of fundamental waves K1 and K2 as compared with the pillar or the like, so that the diffraction efficiency can be increased. Thus, it is possible to provide a two-dimensional exit diffraction grating having a low aspect ratio.

As will be described later, not a transmissive diffraction grating of “PTL 3” but a reflective diffraction grating is adopted regarding the incident diffraction grating of the present embodiment, which can contribute to a reduction in the aspect ratio by utilizing reflection having a large deflection effect with respect to refraction.

In this manner, it is possible to provide the diffraction grating having a low aspect ratio and to provide the light guide plate that can be achieved by the plastic molding technology, such as the injection molding method, is safe and lightweight, and enables high image brightness.

Note that the description will proceed with a coordinate system that has an optical axis direction and the surface of the light guide plate as a Z axis and an X-Y plane, respectively, in the description of the present specification. In addition, when a pupil of the user is approximated to a circle, an exit position in the light guide plate visually recognized by the user depending on a pixel position also becomes a circle. Hereinafter, the exit position will be referred to as an exit circle.

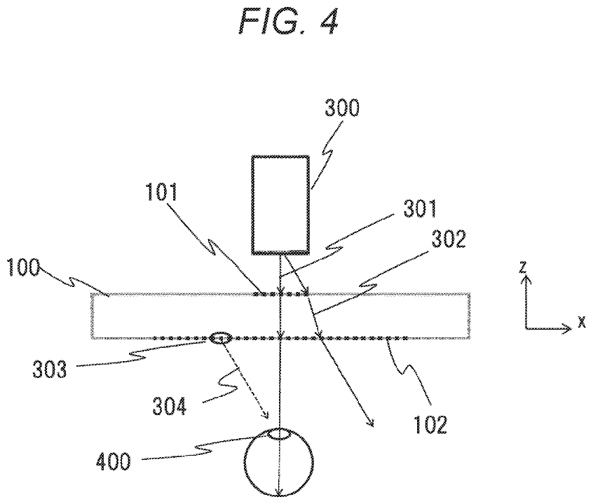

FIG. 4 is a schematic view for describing the exit circle. Here, illustrated is a case where a projector 300 which is a light source configured to form an image and a user's pupil 400 are arranged on opposite sides with respect to the light guide plate 100. Assuming that a wavenumber vector of an incident diffraction grating 101 is oriented in the y direction, arrows in FIG. 4 represent light beams in an x-z plane. Here, it is assumed that the incident diffraction grating 101 does not have a wavenumber vector component in the x direction.

Among image light beams visually recognized by the user's pupil 400, a light beam 301 corresponding to the center of a field of view (display image) travels straight in the x-z plane and reaches the user's pupil 400 as illustrated in the drawing. Diffraction in the y direction, which is caused by an effect of the light guide plate 100, is not explicitly illustrated, but the diffraction occurs at least once by each of the incident diffraction grating 101 and the exit diffraction grating 102.

On the other hand, among the image light beams visually recognized by the user's pupil 400, a light beam 302 corresponding to the periphery of the field of view (display image) travels in the right direction in the drawing in a case where there is no diffraction in the x direction. Meanwhile, in order for the user to recognize this light beam as a projected image, a light beam having the same angle needs to reach the user's pupil 400 through a path indicated as a visually recognized light beam 304 in the drawing. An exit circle 303 is a virtual circle on the exit diffraction grating 102 that is obtained by translating the user's pupil 400 in the direction of the visually recognized light beam. Only the light beam 304 emitted from the exit circle 303 on the exit diffraction grating 102 is recognized as the projected image by the user, and the other light beams are not recognized. In this manner, the diffraction effect in the x direction is required for the exit diffraction grating 102.

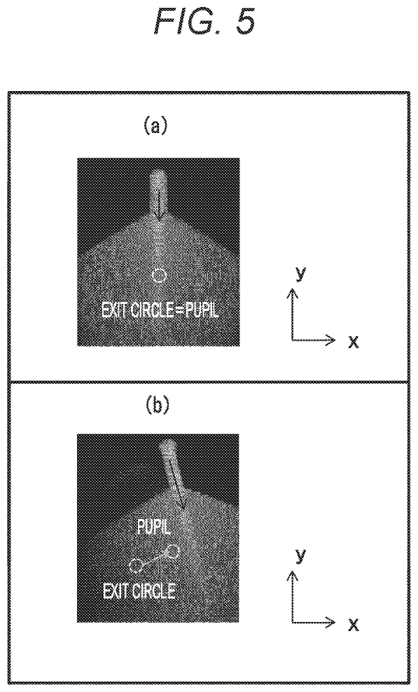

FIG. 5 is an intensity distribution of a light beam propagating inside the light guide plate 100 calculated using a simulation method to be described later. Here, it should be noted that the intensity distribution is illustrated in the x-y plane in the plane including the diffraction gratings of the light guide plate. In the drawing, the incident diffraction grating 101 is arranged on the upper side, and the pupil 400 corresponding to the user's eye is arranged below the incident diffraction grating 101. FIG. 5(a) illustrates a case where a pixel position is located at the center of a projected image, and illustrates an intensity distribution of a light beam at the center of the image. The exit circle in the drawing represents a region where the light beam reaching the pupil is finally diffracted on the exit diffraction grating 102. A high-brightness region on a straight line extending in the y direction from the incident diffraction grating 101 represents a main group of light beams (hereinafter, main light beam group) diffracted by the incident diffraction grating 101 and propagating inside the light guide plate 100. As can be seen in the drawing, there is a characteristic that the intensity is gradually attenuated due to the propagation of the main light beam group. A light beam group with low brightness that spreads around the main light beam group is a light beam group which is diffracted by the exit diffraction grating 102 and of which the traveling direction is deflected in the x-y plane. Under this condition, a light beam to be projected travels in the z axis direction, and thus, it is found that the exit circle and the pupil coincide with each other in the x-y plane. Therefore, a part of the main light beam group with high intensity reaches the pupil and is recognized as the image.

FIG. 5(b) illustrates a case where a pixel position is located at an upper right corner of a projected image, and illustrates an intensity distribution of a light beam in the periphery of the image. As can be seen in the drawing, the main light beam group travels in the lower right direction from the incident diffraction grating 101. Although a position of the pupil is constant, the exit circle is an exit position of a light beam group traveling to the upper right side toward the pupil, and thus, is shifted to the lower left side with respect to the pupil in the x-y plane. In this case, the exit circle is located away from the main light beam group, and thus, a light beam group that reaches the pupil and is recognized as the image has lower brightness as compared with the above case. The above is the main reason why uneven brightness occurs in the case of projecting the image using the light guide plate.

Assuming that a grating pitch is P, the magnitude of the wavenumber vector of the diffraction grating is expressed by K=2π/P as described with reference to FIG. 1. When expressed in the coordinate system having the optical axis direction as the z axis, the wavenumber vector of the incident diffraction grating 101 is K₁=(0, −K, 0). The exit diffraction grating 102 has two wavenumber vectors having an angle of 120 degrees, and the wavenumber vectors are K₂=(+K/√3, K/2, 0) and K₃=(−K/√3, K/2, 0). Assuming that a wavenumber vector of a light beam incident on the light guide plate 100 is kⁱ=(kⁱₓ, kⁱ_{y}, kⁱ_{z}), a wavenumber vector of an emitted light beam is k^{o}=(k^{o}ₓ, k^{o}_{y}, k^{o}_{z}), and K₁, K₂, and K₃ is sequentially applied to kⁱ, k^{o}=kⁱ is established as follows, and it can be seen that a light beam having the same wavenumber vector, that is, the light beam having the same image information, as the incident light beam is emitted.

k^{o}=kⁱ

k^{o}ₓ=kⁱₓ+0+(K/√3)−(K/√3)=kⁱₓ

k^{o}_{y}=kⁱ_{y}+K−(K/2)−(K/2)=kⁱ_{y}

k^{o}_{z}=kⁱ_{z}

Next, a simulation method for analyzing an image display element of the embodiment will be briefly described. A ray tracing method proposed by G. H. Spencer, et al. in 1962 [G. H. Spencer and M. V. R. K. Murty, “General Ray-Tracing Procedure”, J. Opt. Soc. Am. 52, p. 672 (1962)] is a method of paying attention to particulates of light to trace paths thereof and calculating an image or the like that is observed at a point, and continues to be vigorously improved mainly in the field of computer graphics. Monte Carlo ray tracing method based on the ray tracing method [I. Powell “Ray Tracing through systems containing holographic optical elements”, Appl. Opt. 31, pp. 2259-2264 (1992).] is a method of stochastically processing path splitting by diffraction and reflection to prevent an exponential increase in calculation amount, and is suitable for a simulation of a light guide plate which repeats diffraction and propagation in total internal reflection. In the Monte Carlo beam tracing method, reflection and refraction can be faithfully reproduced, but it is essential to develop a suitable model for the diffraction.

A diffraction model, which covers a range of wavelengths (about 400 to 700 nm) over the entire visible light spectrum and an incident angle range suitable for a viewing angle (about 40°) of a projected image, is essential for a light guide plate for an application as a head-mounted display, and the calculation amount becomes enormous with a commercially available simulator. Here, in view of the fact that visually recognized light beams are some of all light beams, an algorithm is used in which the calculation amount is reduced to 1/1000 or less, the algorithm for stopping, in advance, a calculation of a light beam guided to a region that is not visually recognized. Regarding angle and wavelength dependencies of diffraction efficiency obtained by the diffraction grating, calculation results obtained by a finite differential time domain (FDTD) method are tabulated in advance and referred to.

### First Embodiment

Hereinafter, a configuration of the image display element of the embodiment will be described.

<1. Overall Configuration of Image Display Element>

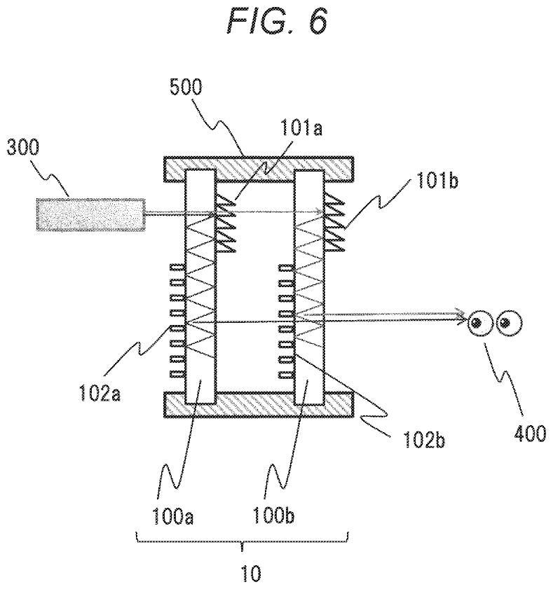

FIG. 6 illustrates a configuration of the image display element of the present embodiment. Here, an image display element 10 includes two light guide plates 100a and 100b in which incident diffraction gratings 101a and 101b and exit diffraction gratings 102a and 102b are formed, respectively. The incident diffraction gratings 101a and 101b are linear surface-relief gratings. The exit diffraction gratings 102a and 102b have the same pattern periods as those of the incident diffraction gratings 101a and 101b, respectively. As the incident diffraction grating 101, a blazed grating having high diffraction efficiency is exemplified, but a type thereof is not particularly limited.

The light guide plates 100a and 100b have different pattern periods P1 and P2, respectively, and cover different ranges of wavelengths. P1 is, for example, 360 nm, and P2 is, for example, 460 nm. Note that the number of the light guide plates 100 is arbitrary, and one or a plurality of (three or more) light guide plates 100 may be provided in accordance with wavelengths of light to be handled. A pattern period of each light guide plate is desirably changed in accordance with to a wavelength to be handled.

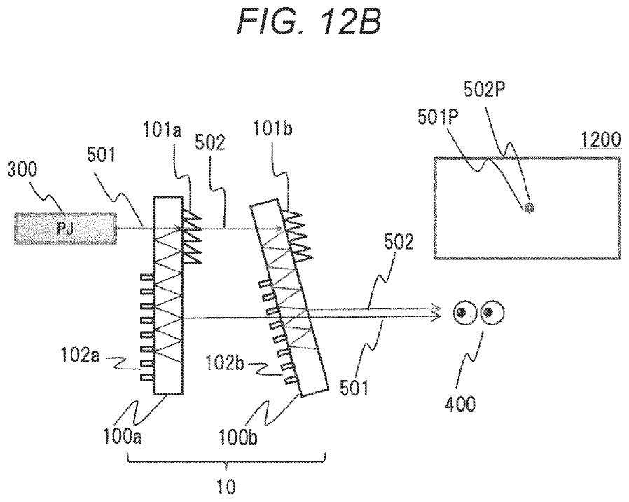

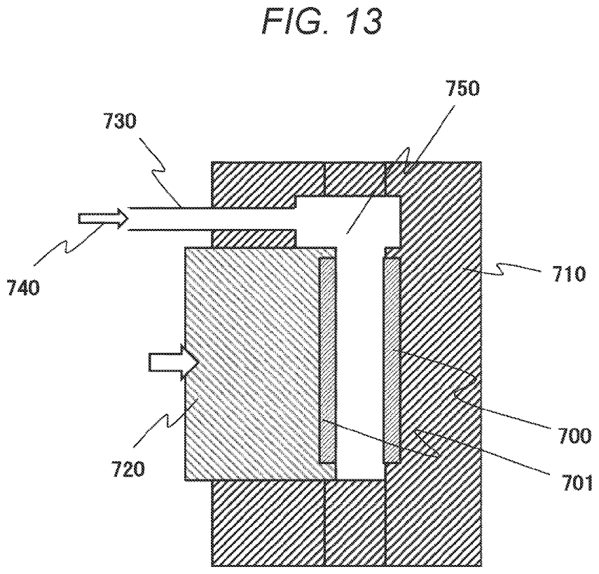

With the configuration of FIG. 6, an image light beam emitted from the projector 300 can be visually recognized by the user. The projector 300 is arranged on the opposite side of the user's pupil 400 with respect to the image display element 10. This arrangement is a so-called transmissive optical configuration, and a reason for adopting this configuration will be described in detail later with reference to FIG. 12B. Note that, in order to achieve the transmissive optical configuration, it is unnecessary for the projector 300 to be physically on the opposite side of the user's pupil 400, and it is sufficient to change a course of a light beam from the projector 300, arranged at any position, by a mirror or the like to be incident on the light guide plate 100 from the opposite side of the user's pupil 400 (the same applies hereinafter).

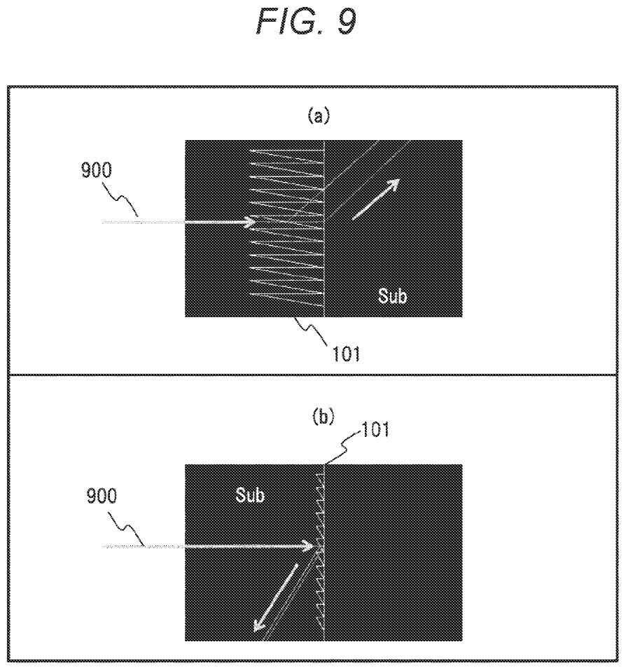

The incident diffraction grating 101 is configured using a reflective diffraction grating. What causes incident light to be reflected and diffracted, that is, to be reflected to the light source side and propagate inside the light guide plate 100 is referred to as the reflective diffraction grating. Therefore, the incident diffraction grating 101 is formed at a position on a surface of the light guide plate 100 far from the projector 300. A reason for adopting this configuration will be described in detail later with reference to FIG. 9.

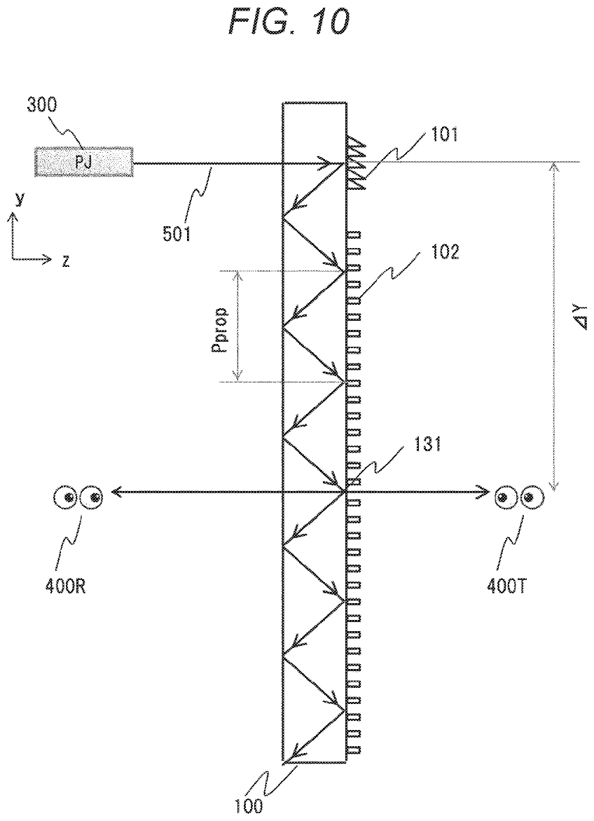

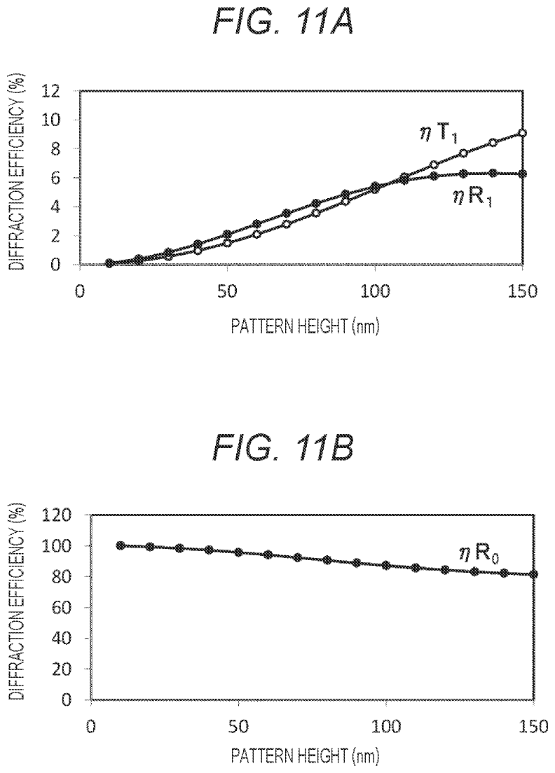

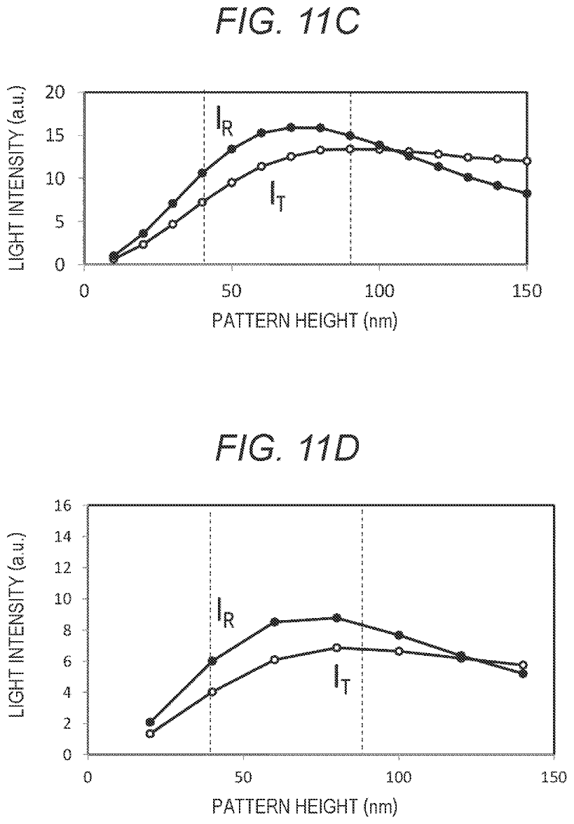

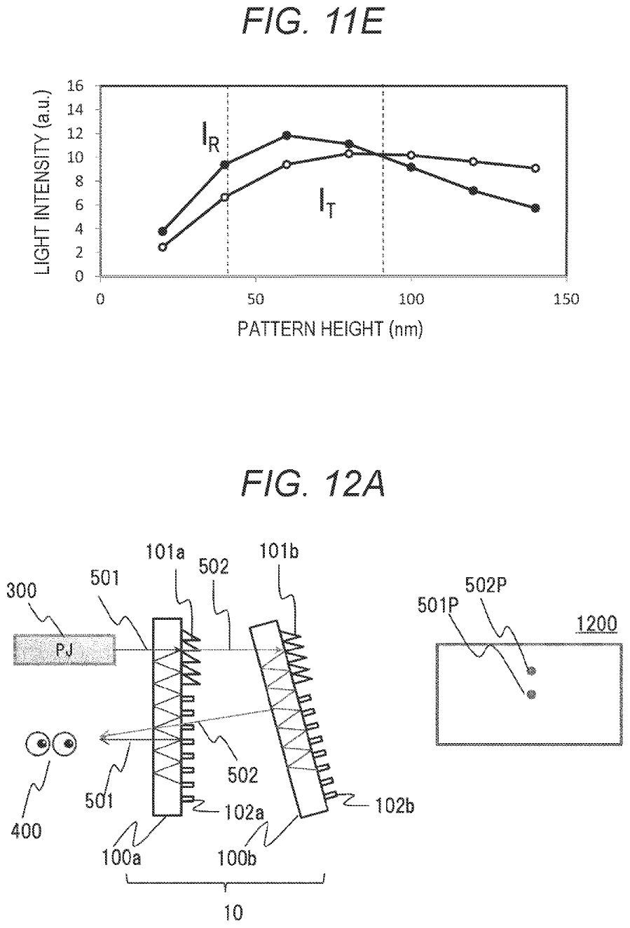

The exit diffraction grating 102 is formed on a surface of the light guide plate 100 opposite to the surface on which the incident diffraction grating 101 is located. A reason for adopting this configuration will be described in detail later with reference to FIGS. 10 to 11C. A shape of the exit diffraction grating 102 may be a linear stripe shape similar to that of the incident diffraction grating 101, or may be the mesh shape illustrated in FIG. 3. When the mesh shape is adopted, there is an effect of further increasing the diffraction efficiency, but the invention does not exclude other shapes of the diffraction grating.

In the present embodiment, the exit diffraction grating 102 is basically formed only on one surface of the light guide plate 100. That is, in the example of FIG. 6, the surface of the light guide plate 100 on the opposite side of the exit diffraction grating 102 is basically flat without a pattern. On the surface on the opposite side of the exit diffraction grating 102, substantially the diffraction does not occur, and the total internal reflection of the light beam occurs ideally. When one exit diffraction grating is dispersedly arranged on both the surfaces of the light guide plate 100, misalignment between the diffraction gratings on both the sides is likely to occur due to thermal expansion or the like of the light guide plate.

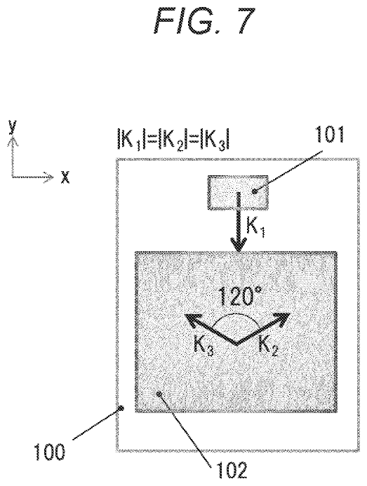

FIG. 7 is a schematic plan view of one light guide plate 100, and illustrates an example of a relation between wavenumber vectors of the incident diffraction grating 101 and the exit diffraction grating 102 thus formed. As described above, in order for the light guide plate 100 to function as the image display element, it suffices that the magnitudes of the wavenumbers K1, K2, and K3 are equal in the drawing and a relation of K1+K2+K3=0 is satisfied.

<2. Configuration of Exit Diffraction Configuration>

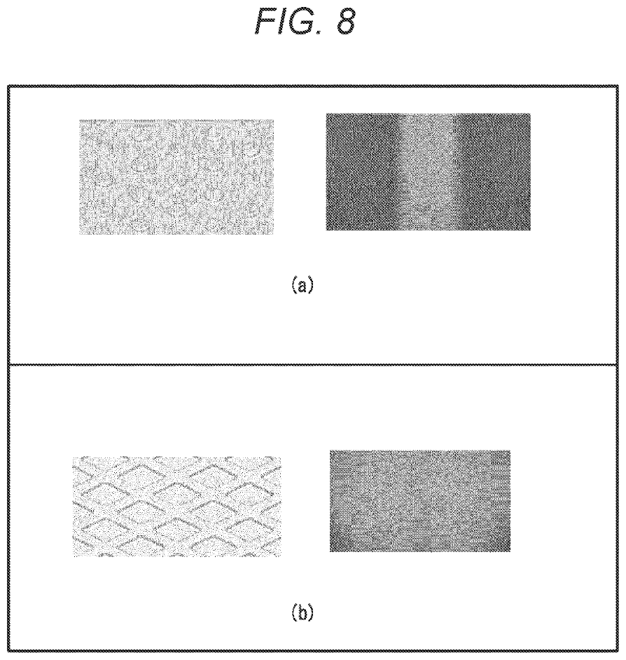

The exit diffraction grating 102 will be described with reference to FIG. 8. Projected images of photonic crystals and a mesh-type diffraction grating in a case of having the same aspect ratio of 0.8 were compared. FIG. 8(a) illustrates the pillar-type photonic crystal described in “PTL 1” and a simulation result of the projected image thereof. FIG. 8(b) illustrates the mesh-type diffraction grating illustrated in FIG. 3 and a simulation result of the projected image thereof. Conditions other than the shape of the diffraction grating are the same. As can be seen from the drawing, in a case where the aspect ratio is 1 or less, it can be seen that brightness at the central portion of the projected image is high and visibility is poor in the photonic crystals. In comparison, the mesh-type diffraction grating having the configuration of FIG. 3 can obtain the favorable projected image with a pattern having a low aspect ratio.

In the mesh-type diffraction grating, a relation among a pattern duty, the diffraction efficiency, and the aspect ratio was simulated. When a pattern pitch of the diffraction grating is p and a pattern width is w, the duty is expressed by w/p. In the simulation, the pattern pitch P was 460 nm, the pattern height was 70 nm, the wavelength of the light beam was 550 nm, the thickness of the light guide plate was 1.0 mm, and the refractive index of the light guide plate was 1.58. A viewing angle of the projected image is 40 degrees.

According to the simulation results, it has been found that first-order diffraction efficiency η1 has a maximum value of about 4.2% at w/p=0.5, and has a characteristic of decreasing as w/p approaches 0 or 1. When the diffraction efficiency of about 0.6% is obtained, w/p of the mesh-type diffraction grating of the present embodiment needs to be determined in a range of 0.15 or more and 0.85 or less. In addition, the efficiency was good in a range where w/p is 0.3 or more and 0.7 or less, and the efficiency was best in a range where w/p is 0.4 or more and 0.6 or less.

Regarding the aspect ratio of the pattern, the aspect ratio increases as w/p approaches 1 or 0 since the pattern height is fixed at 70 nm. When the aspect ratio of the pattern being 1 or less is set as a reference for adaptation of an injection molding method or the like, w/p of the mesh-type diffraction grating of the present embodiment needs to be determined in the range of 0.15 to 0.85. In addition, manufacturing becomes the easiest with the minimum aspect ratio when w/p=0.5.

From the above, in principle, it can be said that the diffraction efficiency of the mesh-type diffraction grating is maximum and the aspect ratio of the pattern is minimum when w/p=0.5, that is, w=p−w.

<3. Configuration of Incident Diffraction Grating>

The incident diffraction grating 101 will be described with reference to FIG. 9. Here, a blazed grating is taken as an example of the incident diffraction grating 101. FIG. 9(a) is a simulation result of a transmissive diffraction grating which is the same as that of “PTL 3”. In the transmissive diffraction grating, incident light is transmitted and diffracted, and propagates inside the light guide plate (substrate). The incident diffraction grating is formed at a position on a surface of the light guide plate close to the light source.

In FIG. 9(a), an image light beam 900 is incident from the left, and the right half of the drawing represents a substrate (Sub). In the transmissive diffraction grating, the maximum diffraction efficiency is obtained under a condition that refraction by a blaze surface and diffraction by a periodic structure are tuned in phase. In order to achieve this, a height of a corrugated pattern of the incident diffraction grating 101 needs to be large, an angle of the pattern needs to be between 70 degrees and 80 degrees, and an aspect ratio obtained by dividing the height of the pattern by a period needs to be 10 or more as illustrated in the drawing. In a general plastic molding method such as injection molding, when an aspect ratio exceeds 1, a problem such as deterioration of transferability occurs, and the yield at the time of mass production decreases. It is found that the transmissive diffraction grating illustrated here is not suitable as the incident diffraction grating of the present embodiment.

FIG. 9(b) is a simulation result of the reflective diffraction grating. In the reflective diffraction grating, incident light is reflected and diffracted, that is, reflected to the light source side and propagates inside the light guide plate (substrate). The incident diffraction grating 101 is formed on a surface far from the light source of the light guide plate.

An image light beam is similarly incident from the left, and the left half of the drawing represents the substrate (Sub). In the reflective diffraction grating, the maximum diffraction efficiency is obtained under a condition that reflection by a blaze surface and diffraction by a periodic structure are tuned in phase. As can be seen from the drawing, it is found that this condition is satisfied with a corrugated pattern having a lower aspect ratio than that of the transmissive type. At this time, a height of the corrugated pattern is about 250 nm, and the aspect ratio is about 0.57. In a prototype element described hereinbefore, a triangular corrugated pattern having a pattern height of 374 nm could be favorably transferred. It can be said that the incident diffraction grating suitable for the light guide plate made of plastic in the present embodiment is a reflective incident diffraction grating.

<4. Study on Diffraction Efficiency of Light Guide Plate>

FIG. 10 is a schematic view illustrating a path of a light beam visually recognized by the user through the light guide plate 100. Light intensities visually recognized by a user's pupil 400T on the same side as the exit diffraction grating 102 of the light guide plate 100 and a user's pupil 400R on the opposite side of the exit diffraction grating 102, respectively, are compared and studied.

In the drawing, an image light beam 501 emitted from the projector 300 is diffracted by the incident diffraction grating 101, propagates in total internal reflection through the light guide plate 100, is diffracted at a point 131 in an exit circle (not illustrated) on the exit diffraction grating 102, and is visually recognized by the user. When the user's pupil 400T is located on the same side as the exit diffraction grating 102 with respect to the light guide plate 100, the visually recognized image light beam is transmitted and diffracted at the point 131. Thus, the transmissive diffraction efficiency is dominant in the visually recognized light intensity. On the other hand, when the user's pupil 400R is located on the opposite side of the exit diffraction grating 102 with respect to the light guide plate 100, the visually recognized image light beam is reflected and diffracted at the point 131. Thus, the reflective diffraction efficiency is dominant in the visually recognized light intensity.

A pitch Pprop of the propagation in total internal reflection inside the light guide plate 100 is uniquely determined by a pitch of the incident diffraction grating 101, a refractive index and a thickness of the light guide plate 100, a wavelength and an incident angle of the image light beam 501. The image light beam intersects with the exit diffraction grating N times (=ΔY/Pprop) until reaching the point 131. Thus, when a light intensity of the image light beam 501 is I₀ and zero-order reflective diffraction efficiency and first-order transmissive diffraction efficiency of the exit diffraction grating 102 are respectively ηR₀ and ηT₁, a light intensity I_{T} visually recognized by the pupil 400T of the user is approximated as

I_{T}=I₀·(ηR₀)^{N-1}·(ηT₁) (1).

Similarly, when first-order reflective diffraction efficiency of the exit diffraction grating is ηR₁, a light intensity I_{R} visually recognized by the pupil 400R of the user is approximated as

I_{R}=I₀·(ηR₀)^{N-1}·(ηR₁) (2).

FIGS. 11A to 11C are calculation results of visual recognized brightness obtained by an approximate calculation. Here, the diffraction efficiency of the light guide plate 100 is calculated by an FDTD method. An image light beam corresponding to a central pixel of a projected image was calculated under a condition that a wavelength is 550 nm, a refractive index of the light guide plate 100 is 1.58, a thickness is 1 mm, a distance ΔY from the incident diffraction grating 101 to the center of a line of sight of the user is 17 mm, a pattern period of the diffraction grating is 460 nm, and a width of a convex portion is 150 nm. Under this condition, the pitch Pprop of total internal reflection and propagation is 2.32 mm, and the number of intersections N between the exit diffraction grating 102 and the image light beam is 7.3.

FIG. 11A illustrates a relation between a pattern height of a convex portion of the exit diffraction grating 102 and the first-order diffraction efficiency of reflection and transmission at the point 131 in FIG. 13. As can be seen in the drawing, in a region where the height of the convex portion is 100 nm or less (the aspect ratio<2/3 since the width of the convex portion is 150 nm), the first-order diffraction efficiency is ηR₁>ηT₁. That is, when the diffraction grating pattern having the aspect ratio of less than 2/3 is used, the reflective diffraction is more efficient. In addition, in a region where the height of the convex portion is 50 nm or more (1/3<the aspect ratio), the diffraction efficiency of 2% or more can be obtained.

FIG. 11B illustrates a relation between the pattern height of the convex portion of the exit diffraction grating 102 and the zero-order reflective diffraction efficiency at the point 131 in FIG. 13. As can be seen in the drawing, ηR₀ decreases as the height of the convex portion increases.

The above discussion regarding the diffraction efficiency relates to the diffraction efficiency at the point 131 in FIG. 13. In the light guide plate, the light beam is reflected a plurality of times inside the light guide plate until reaching the point 131. Thus, a loss caused by the plurality of times of reflection is represented by ηR₀^{N-1} in Formulas (1) and (2) described above. It is necessary to consider Formulas (1) and (2) regarding the light intensity that can actually be visually recognized by the user.

FIG. 11C illustrates a relation between the pattern height of the convex portion of the exit diffraction grating and the light intensity visually recognized by the user based on Formulas (1) and (2). As can be seen from the drawing, it is found that I_{R} using the first-order reflective diffraction has a larger maximum value than I_{T} using the first-order transmissive diffraction. In addition, when a diffraction grating pattern having a low aspect ratio is used, the intensity of I_{R} using the first-order reflective diffraction is higher. Since transferability by an injection molding method or the like is more excellent as the height of the convex portion is lower, it is possible to increase the brightness visually recognized by the user when the first-order reflective diffraction is utilized as the light guide plate 100.

From the above study, it can be said that a positional relation in which the pupil 400R of the user is located on the opposite side of the exit diffraction grating 102 with respect to the light guide plate 100 is desirable from the viewpoint of the brightness visually recognized by the user regarding the arrangement of the light guide plate 100 and the exit diffraction grating 102 illustrated in FIG. 10.

FIGS. 11D and 11E illustrate the relation between the pattern height of the convex portion of the exit diffraction grating and the light intensity visually recognized by the user. Illustrated are calculation results of the visually recognized brightness with respect to different optical wavelengths obtained by an approximate calculation.

FIG. 11D illustrates a result in a case where a light beam having a wavelength of 635 nm is incident on the same light guide plate as described above. Similarly to FIG. 11C, it is found that I_{R} using the first-order reflective diffraction has a larger maximum value than I_{T} using the first-order transmissive diffraction. Since transferability by an injection molding method or the like is more excellent as the height of the convex portion is lower, it is possible to increase the brightness visually recognized by the user when the first-order reflective diffraction is utilized as the light guide plate.

FIG. 11E illustrates a result in a case where a light beam having a wavelength of 460 nm is incident. Here, a pattern period of the diffraction grating is set to 360 nm in accordance with the wavelength of 460 nm, which is an example of a condition corresponding to the light guide plate 100 in FIG. 1. Similarly, it is found that I_{R} using the first-order reflective diffraction has a larger maximum value than I_{T} using the first-order transmissive diffraction. Since transferability by an injection molding method or the like is more excellent as the height of the convex portion is lower, it is possible to increase the brightness visually recognized by the user when the first-order reflective diffraction is utilized as the light guide plate.

From the examples of FIGS. 11C to 11E, it is found that the first-order reflective diffraction exhibits more excellent efficiency than the first-order transmissive diffraction when the pattern height of the diffraction grating is approximately 100 nm or less in the visible light region. The pattern height is desirably 30 nm or more at minimum. More preferably, it is found that strong visible light intensity is obtained by the reflective diffraction in the illustrated pattern height range of 40 nm or more and 90 nm or less.

<5. Study on Influence of Inclination of Light Guide Plate>

Next, a case where first-order reflective diffraction is performed by the exit diffraction grating 102 to allow the user to visually recognize image light is considered. In this case, the exit diffraction grating 102 is arranged on a surface of the light guide plate 100 on the opposite side of the user's pupil 400.

FIG. 12A is a schematic view in which the projector 300 and the user's pupil 400 have a relation of being located on the same side with respect to the light guide plate 100.

FIG. 12B is a schematic view in which the projector 300 and the user's pupil 400 have a relation of being located on opposite sides with respect to the light guide plate 100.

The influence of a relative inclination between the two light guide plates 100a and 100b will be described with reference to FIGS. 12A and 12B. In FIGS. 12A and 12B, the light guide plate 100 includes the light guide plates 100a and 100b respectively covering different wavelengths. In addition, the projector for image projection is denoted by 300, the pupil of the user is denoted by 400, and projected image light beams are denoted by 501 and 502.

FIG. 12A illustrates the case where the projector 300 and the user's pupil 400 are arranged on the same side with respect to the light guide plate 100. The reflective incident diffraction grating 101 is formed on a surface (right surface in the drawing) of the light guide plate 100 far from the projector 300. As illustrated in the drawing, the light guide plate 100 finally reflects the image light beams 501 and 502 to be delivered to the user's pupil 400. Therefore, if the light guide plate 100b (or 100a) is inclined with respect to the light guide plate 100a (or 100b), pixel positions 501P and 502P of the visually recognized image light beams 501 and 502 are shifted depending on wavelengths of the projected light beams as illustrated in a field-of-view image 1200 of the user, and the image quality is degraded. Since resolving power for a light beam angle of the user with the eyesight of 1.0 is 1/60 degrees, the relative inclination between the two light guide plates 100a and 100b needs to be sufficiently smaller than 1/60 degrees based on such a fact, and the implementation as the head-mounted display is difficult with the plastic light guide plate having smaller mechanical strength (Young's modulus) than the conventional one made of glass.

FIG. 12B illustrates a case where the projector 300 and the user's pupil 400 are arranged on the opposite sides with respect to the light guide plate 100. The reflective incident diffraction grating 101 is formed on a surface (left surface in the drawing) of the light guide plate 100 close to the projector 300. As illustrated in the drawing, the light guide plate 100 finally transmits image light beams 501 and 502 to be delivered to the user's pupil 400. Since angles of incident light and emitted light are basically the same, in principle, the shift in the pixel positions 501P and 502P of the projected image depending on the wavelengths does not occur even if the relative inclination exists between the light guide plates 100a and 100b. Therefore, in a case where the plastic light guide plate of the present embodiment is mounted on the head-mounted display, it is desirable to arrange the light source of the projector 300 on the opposite side of the user's pupil 400 with respect to the light guide plate 100 (to adopt the transmissive optical configuration). In this case, the exit diffraction grating 102 needs to be formed on the surface of the light guide plate 100 on the side opposite to the incident diffraction grating 101.

Note that the relative inclination between the light guide plates 100a and 100b is desirably suppressed to about 3 degrees or less since an angle condition for a light beam that is guided in total internal reflection inside the light guide plate 100 is actually affected. In this case, the user can be provided with the image information with higher brightness as the transmissive diffraction efficiency of the exit diffraction grating 102 increases.

Note that the projector 300 is arranged on the left side of the light guide plate 100 in FIGS. 12A and 12B, but it suffices that a light beam is incident on the light guide plate 100 from the left side, and the position of the projector 300 is not limited. For example, the projector 300 may be arranged on the right side of the light guide plate 100, and a light beam may be incident from the left side of the light guide plate 100 by changing a direction of the light beam with a mirror or the like.

The diffraction efficiency when light propagating through the light guide plate 100 is diffracted by the exit diffraction grating 102 and emitted from the light guide plate 100 was calculated by the FDTD method. The reflective diffraction efficiency was 3.5% and the transmissive diffraction efficiency was 2.8% under a condition that a wavelength is 550 nm, a refractive index of the light guide plate 100 is 1.58, a pattern period of the diffraction grating is 460 nm, a width of a convex portion is 150 nm, a height of the convex portion is 70 nm, and light corresponding to a central pixel of a projected image is coupled by incident diffraction and propagates in total internal reflection inside the light guide plate 100. An aspect ratio of a corrugated pattern is 0.47.

It is a matter of course that a manufacturing process is simpler in a case where the incident diffraction grating 101 and the exit diffraction grating 102 are simultaneously formed only on one surface of the light guide plate 100. In the configuration of FIG. 12B, if the exit diffraction grating 102 is formed on the same surface as the incident diffraction grating 101, the light beam transmitted and diffracted by the exit diffraction grating 102 is visually recognized by the user. Therefore, when the incident diffraction grating 101 and the exit diffraction grating 102 are formed on the same surface in the transmissive optical configuration illustrated in FIG. 12B, the brightness of the projected image visually recognized by the user decreases as compared with the reflective optical configuration in FIG. 12A.

In the present embodiment, the exit diffraction gratings 102a and 102b are formed on the surfaces opposite to the incident diffraction gratings 101a and 101b, respectively, as illustrated in FIGS. 6 and 12B. At this time, the light beam is visually recognized by the user by the reflective diffraction even in the transmissive optical configuration of FIG. 12B, it is possible to provide the image information with high brightness.

<6. Study on Ideal Image Display Element>

A desirable configuration of an image display element will be studied by putting the findings described in the above embodiment together.

In a case where plastic is used as a light guide plate, a reflective diffraction grating having a low aspect ratio is preferable since it is difficult to form a pattern having a high aspect ratio in an incident diffraction grating having high diffraction efficiency as described with reference to FIG. 9.

Then, the reflective incident diffraction grating 101 reflects light to the inside of the light guide plate 100, and thus, is arranged on a surface (second surface) of the light guide plate on a side opposite to an incident surface (first surface) of an image light beam as illustrated in FIG. 10.

In addition, in a case where a plurality of the light guide plates 100 are used, a transmissive optical configuration in which light is emitted to the side (second surface) opposite to the incident surface (first surface) of the light beam is desirable in order to reduce a shift of a visually recognized pixel position as described in FIGS. 12A and 12B.

In addition, the light guide plate 100 can have a configuration in which the user visually recognizes light in which first-order reflective diffraction is dominant, and thus, the visually recognized brightness can be increased with a low aspect ratio as described with reference to FIGS. 11A to 11E. Thus, the exit diffraction grating 102 is preferably arranged on the first surface such that the first-order reflective diffraction light is emitted to the second surface. From the above, the configuration in which the incident diffraction grating 101 is arranged on the second surface and the exit diffraction grating 102 is arranged on the first surface is recommended.

According to the present embodiment, the exit diffraction grating is formed on the surface on the opposite side of the incident diffraction grating in the light guide plate (image display element) having the surface-relief grating, and thus, the exit diffraction efficiency can be increased to 4% or more. In addition, when the mesh-type exit diffraction grating illustrated in FIG. 3 is used, the light guide plate can be easily made using plastic by the injection molding method or the like, and the light guide plate that is safe, lightweight, and enables high brightness can be achieved.

### Second Embodiment

FIG. 13 is a schematic view of a method of integrally molding the incident diffraction grating 101 and the exit diffraction grating 102 on both surfaces of the light guide plate 100 illustrated in FIG. 6 by a plastic molding technology.

A conventionally used light guide plate, such as a nanoimprint method or etching, is prepared by a surface processing technology based on a semiconductor processing technology. On the other hand, since the plastic molding technology, such as the injection molding method, is a three-dimensional molding technology of introducing resin into a mold and solidifying the resin, it is easy to form the diffraction gratings on both the surfaces of the light guide plate.

In the drawing, stampers 700 and 701 respectively having surfaces on which a surface of a diffraction grating that needs to be formed is formed in inverted concave-convex forms are fixed to a fixed portion 710 and a movable portion 720 of a mold, respectively. When molten resin 740 is injected from a resin flow path 730 using such a mold and the movable portion 720 of the mold is moved in the right direction in the drawing to apply pressure, the resin 740 can be formed into a shape along a shape of a cavity 750, and a desired light guide plate can be formed through a cooling process. This method is a general method, and the light guide plate in which the diffraction gratings are formed in concave and convex shapes on both the surfaces can be made of plastic using the two stampers.

### Third Embodiment

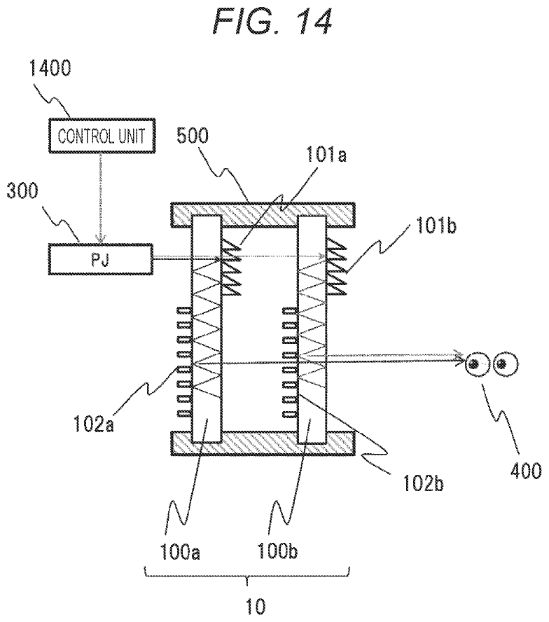

FIG. 14 is a schematic view illustrating a configuration of an image display device of an embodiment. Light that has image information and is emitted from the projector 300 in the drawing reaches the user's pupil 400 by the effect of the light guide plate 100, thereby realizing an augmented reality. In each of the light guide plates 100, a pitch and a depth of a diffraction grating to be formed are optimized according to each color. The number of the light guide plates 100 may be arbitrary, but generally, three light guide plates are used respectively for beams of red, blue, and green light.

In the drawing, the image display device of the present embodiment includes the light guide plate 100, the projector 300, and a display image control unit 1400. In addition, as an image formation method, widely known image formation devices can be used, for example, an image formation device including a reflective or transmissive spatial light modulator, a light source, and a lens, an image formation device including organic and inorganic electro luminescence (EL) element arrays and a lens, an image formation device including a light emitting diode array and a lens, an image formation device including a combination of a light source, a semiconductor micro electro mechanical systems (MEMS) mirror array, and a lens, and the like.

In addition, a device that causes resonant movement of a light emitting diode (LED), a laser light source, and a tip of an optical fiber by a MEMS technology, lead zirconate titanate (PZT), or the like can also be used. Among them, the most general device is the image formation device including the reflective or transmissive spatial light modulator, the light source, and the lens. Here, examples of the spatial light modulator include a transmissive or reflective liquid crystal display device such as a liquid crystal on silicon (LCOS), and a digital micromirror device (DMD). As the light source, a white light source from which light is separated into RGB components may be used, or LEDs or laser sources corresponding to the respective colors may be used.

Furthermore, the reflective spatial light modulator can be configured using a liquid crystal display and a polarization beam splitter which reflects and guides a part of light from the light source to the liquid crystal display and allows passage of a part of the light reflected by the liquid crystal display to be guided to a collimating optical system that uses a lens. Examples of a light emitting element constituting the light source can include a red light emitting element, a green light emitting element, a blue light emitting element, and a white light emitting element. The number of pixels may be determined according to specifications required for the image display device, and examples of specific values of the number of pixels can include 320×240, 432×240, 640×480, 1024×768, and 1920×1080 in addition to 1280×720 mentioned above.

In the image display device of the present embodiment, the projector 300 is formed to be integrated with the light guide plate 100 by being positioned such that a light beam that has image information and has been emitted from the projector 300 is emitted to each of the incident diffraction gratings 101 of the light guide plate 100.

In addition, a display image control unit (not illustrated) performs a function of controlling the operation of the projector 300 and appropriately providing the image information to the user's pupil 400.

In the embodiments described above, the incident and exit diffraction gratings and the exit diffraction grating are integrally molded using the material having the same refractive index as that of the waveguide by the injection molding method or the like in the light guide plate (image display element) having the surface-relief grating, and thus, it is possible to make the light guide plate using plastic and achieve the safe and lightweight light guide plate. That is, the light guide plate that has favorable performance with the surface irregularities having the aspect ratio of 1 or less can be prepared by the injection molding method, and it is possible to achieve the improvement in safety and reduction in weight by making the light guide plate using plastic.

In addition, the incident diffraction grating 101 and the exit diffraction grating 102 are formed on opposing surfaces of the light guide plate 100, and the brightness of the visually recognized image can be improved by improving the diffraction efficiency using the reflective diffraction. The case where the image information is provided to the user has been described in the present embodiment, and the image display device of the present embodiment can include various sensors such as a touch sensor, a temperature sensor, and an acceleration sensor configured to acquire information regarding the user and the external environment, and an eye tracking mechanism configured to measure movement of the user's eye.

### REFERENCE SIGNS LIST

100 light guide plate
101 incident diffraction grating
102 exit diffraction grating
300 projector
400 pupil of user

1. An image display element comprising:
a substrate made of resin;
an incident diffraction grating that diffracts incident light; and
an exit diffraction grating that emits the light, wherein
the incident diffraction grating is formed on a first surface of the substrate,
the exit diffraction grating is formed on a second surface on a side opposite to the first surface of the substrate, and
the exit diffraction grating is formed on one surface.

2. The image display element according to claim 1, wherein
the incident diffraction grating is formed on a first surface of the substrate using a material identical to a material of the substrate, and
the exit diffraction grating is formed on a second surface on a side opposite to the first surface of the substrate using a material identical to the material of the substrate.

3. The image display element according to claim 2, wherein
the incident diffraction grating and the exit diffraction grating have aspect ratios of 1 or less.

4. The image display element according to claim 3, wherein
the aspect ratio of the exit diffraction grating is 2/3 or less.

5. The image display element according to claim 2, wherein
the exit diffraction grating has a mesh shape.

6. The image display element according to claim 5, wherein
the exit diffraction grating is formed of a corrugated pattern, and the corrugated pattern includes a first group of parallel straight lines and a second group of parallel straight lines intersecting the first group of parallel straight lines,
a pitch of the first group of parallel straight lines and a pitch of the second group of parallel straight lines are equally P, and
W/P is 0.15 or more and 0.85 or less as a relation between the pitch P of the first group of parallel straight lines and the second group of parallel straight lines and a width W of the corrugated pattern.

7. The image display element according to claim 2, wherein
the exit diffraction grating has a corrugated pattern, and a pattern height of the corrugated pattern is 100 nm or less.

8. The image display element according to claim 7, wherein
the exit diffraction grating has a corrugated pattern, and a pattern height of the corrugated pattern is 40 nm or more and 90 nm or less.

9. The image display element according to claim 2, wherein
the incident diffraction grating is a reflective blazed grating.

10. An image display device comprising:
a projector that is a light source configured to form an image;
an incident diffraction grating formed on a first surface of a substrate made of resin, the incident diffraction grating diffracting incident light that is emitted from the projector and has image information; and
an exit diffraction grating formed on a second surface on a side opposite to the first surface, wherein
the exit diffraction grating is formed on one surface of the substrate, and
a plurality of the substrates are provided for wavelengths of the light source.

11. The image display device according to claim 10, wherein
the projector is provided on the side of the second surface.

12. The image display device according to claim 11, wherein
the incident light has a wavelength of 460 to 635 nm.

13. An image display method that is performed using an image display element including a substrate made of resin, an incident diffraction grating formed on a first surface of the substrate, and an exit diffraction grating formed on a second surface on a side opposite to the first surface of the substrate, the exit diffraction grating being formed on one surface, the image display method comprising:
causing image light to be incident on the incident diffraction grating;
causing the image light reflected and diffracted by the incident diffraction grating to propagate inside the substrate; and
displaying an image by allowing a user to visually recognize the image light reflected and diffracted by the exit diffraction grating and emitted from the first surface.

14. The image display method according to claim 13, wherein
the aspect ratio of the exit diffraction grating is 2/3 or less.

15. The image display method according to claim 13, wherein
the exit diffraction grating has a mesh shape.
